(19) United States
(12) Patent Application Publication
(10) Pub. No.: US 2024/0372348 A1
(43) Pub. Date: Nov. 7, 2024

(54) ELECTRICAL JUNCTION BOX

(71) Applicant: SUMITOMO WIRING SYSTEMS, LTD., Mie (JP)

(72) Inventor: Shunsuke KATSUSE, Mie (JP)

(21) Appl. No.: 18/285,581

(22) PCT Filed: Mar. 17, 2022
(86) PCT No.: PCT/JP2022/012349

§ 371 Date: Oct. 4, 2023

(30) Foreign Application Priority Data
Apr. 9, 2021 (JP) 2021-066184

(51) Int. Cl. H02G 3/16

(52) U.S. Cl. CPC H02G 3/16

(57) ABSTRACT

To provide an electrical junction box that is excellent in terms of workability during assembly. An electrical junction box (A) includes: a base member (10) to which electric components (58) are to be attached; and plates (28) that are connected to the electric components (58), wherein the base member (10) includes housing spaces (25) in which the plates (28) are housed, and openings (27) that open the housing spaces (25) to outer surfaces of the base member (10), and the base member (10) has formed therein separation-restricting portions (34) that restrict the plates (28) inside the housing spaces (25) from separating from the openings (27).

### TECHNICAL FIELD

The present disclosure relates to an electrical junction box.

### BACKGROUND

Patent Document 1 discloses an electrical junction box in which busbars are attached to an electronic component block made from resin. The busbars are attached to the electronic component block by being pushed into busbar attachment portions of the electric component block using a surface-pressing jig.

### PRIOR ART DOCUMENT

### Patent Document

Patent Document 1: JP 2020-080587 A

### SUMMARY OF THE INVENTION

### Problems to be Solved

In the above-described electrical junction box, the busbars are pressed against the busbar attachment portions so strongly that a surface-pressing jig needs to be used. Because the busbars need to be pressed against the busbar attachment portions strongly, it can be inferred that the busbars are held in an attached state by frictional resistance produced by a press-fitting structure. However, the burden on a worker when carrying out the work of using the surface-pressing jig and pressing the busbars strongly against friction is great.

As a countermeasure against this problem, a structure is conceivable in which each busbar is dropped into a groove portion formed in the electric component block by its own weight, and an opening of the groove portion is covered with another member. However, with this structure, the busbar would fall due to its own weight if the electrical junction box is turned upside-down in a state in which the opening of the groove portion is not covered with the other member. Thus, there still remains a problem in terms of workability during assembly because a worker would need to cover the opening with his/her hand.

An electrical junction box according to the present disclosure has been made based on the above-described circumstances, and one aim is to provide an electrical junction box having excellent workability during assembly.

### Means to Solve the Problem

An electrical junction box according to the present disclosure includes: a base member to which electric components are to be attached; and connection members to be connected to the electric components,
wherein the base member includes housing spaces in which the connection members are housed, and openings that open the housing spaces to outer surfaces of the base member, and
the base member has formed therein separation-restricting portions that restrict the connection members inside the housing spaces from separating from the openings.

### Effect of the Invention

According to the present disclosure, an electrical junction box having excellent workability during assembly can be provided.

### BRIEF DESCRIPTION OF THE DRAWINGS

FIG. 1 is a perspective view of an electrical junction box according to embodiment 1.

FIG. 2 is a perspective view illustrating a state in which the electrical junction box has been separated into a base member and side-wall members.

FIG. 3 is a perspective view illustrating a state in which electric components have been attached to the base member.

FIG. 4 is a perspective view illustrating a state in which the base member has been separated into a holding member, a terminal block, and connection members.

FIG. 5 is a perspective view illustrating a state in which a side-wall member has been separated into a side-wall main body and a busbar.

FIG. 6 is a partially enlarged side view illustrating a state in which the separation of a connection member is restricted by a separation-restricting portion.

FIG. 7 is a partially enlarged front view illustrating a state in which the separation of the connection member is restricted by the separation-restricting portion.

### DETAILED DESCRIPTION TO EXECUTE THE INVENTION

### Description of Embodiments of Present Disclosure

First, aspects of embodiment of the present disclosure will be listed and described.
(1) The electrical junction box according to the present disclosure includes: a base member to which electric components are to be attached; and connection members to be connected to the electric components, wherein the base member includes housing spaces in which the connection members are housed, and openings that open the housing spaces to outer surfaces of the base member, and the base member has formed therein separation-restricting portions that restrict the connection members inside the housing spaces from separating from the openings. According to the configuration of the present disclosure, the connection members are held in a state of being housed inside the housing spaces by the separation-restricting portions even if the base member is placed in positions in which the openings are oriented downward. Accordingly, the workability during the attachment of other members to the base member and the connection members is excellent.
(2) Preferably, the base member includes a holding member that holds the electric components, and a terminal block to which the connection members are fixed, wherein spaces between the holding member and the terminal block function as the housing spaces. According to this configuration, the connection members can be housed inside the housing spaces by interposing the connection members between the holding member and the terminal block when the holding member and the terminal block are attached to one another. Workability during assembly is excellent because the assembly of the base member and the attachment of the connection members to the base member can be performed simultaneously in a single process.
(3) Preferably, in (2), the holding member is capable of holding the electric components in a quantity that is greater than the quantity of the connection members, and the separation-restricting portions are formed only in the terminal block. Because the holding member needs to have a structure for holding the plurality of electric components, there is a concern that the shape of the holding member may become complicated. In view of this, the separation-restricting portions are formed in the terminal block, which has a simpler shape than the holding member. Thus, an increase in complexity of the shape of the holding member that may otherwise occur due to the separation-restricting portions being formed in the holding member can be avoided, and the die cost for molding the holding member can be reduced.
(4) Preferably, busbars that include a substrate portion, a quarter-circular-arc-shaped bend portion that extends from the substrate portion, and a connection plate portion that extends from the bend portion in the right-angle direction relative to the substrate portion are included, the busbars are disposed in a state in which the connection plate portions are placed on the connection members and the bend portions face outer side surfaces of the terminals, and the separation-restricting portions are disposed between the connection members and the bend portions. According to this configuration, because the separation-restricting portions are disposed in dead spaces between the connection members and the bend portions, dedicated spaces for disposing the separation-restricting portions are unnecessary.
(5) Preferably, the base member includes a component housing chamber for housing the electric components, the component housing chamber is open to the sides of the base member, side-wall members for covering the sideways-open surfaces of the component housing chamber are attached to the base member, and the side-wall members cover the openings of the housing spaces. According to this configuration, the connection members can be reliably prevented from separating from the housing spaces, by means of the side-wall members.

### Details of Embodiments of Present Disclosure

### Embodiment 1

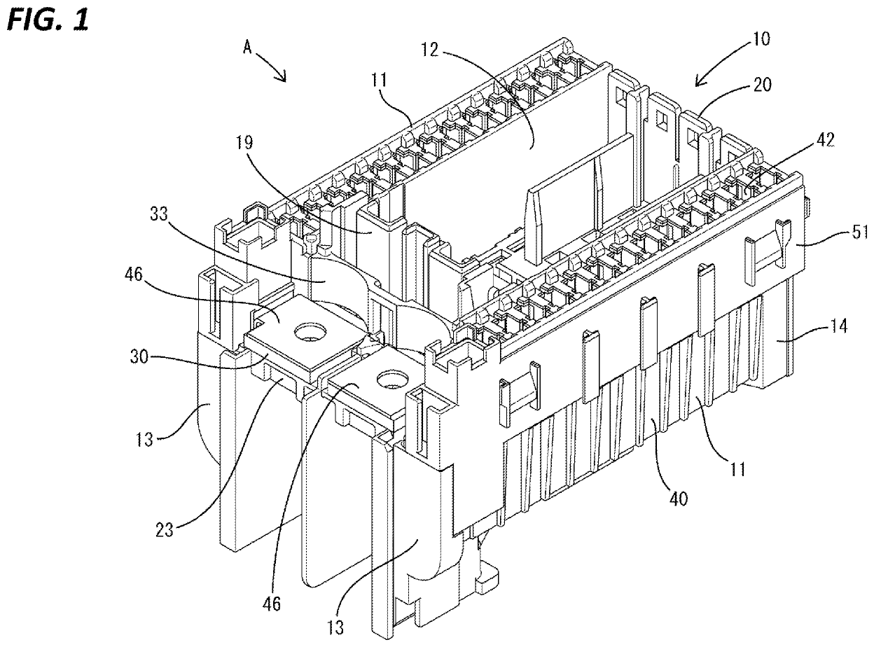

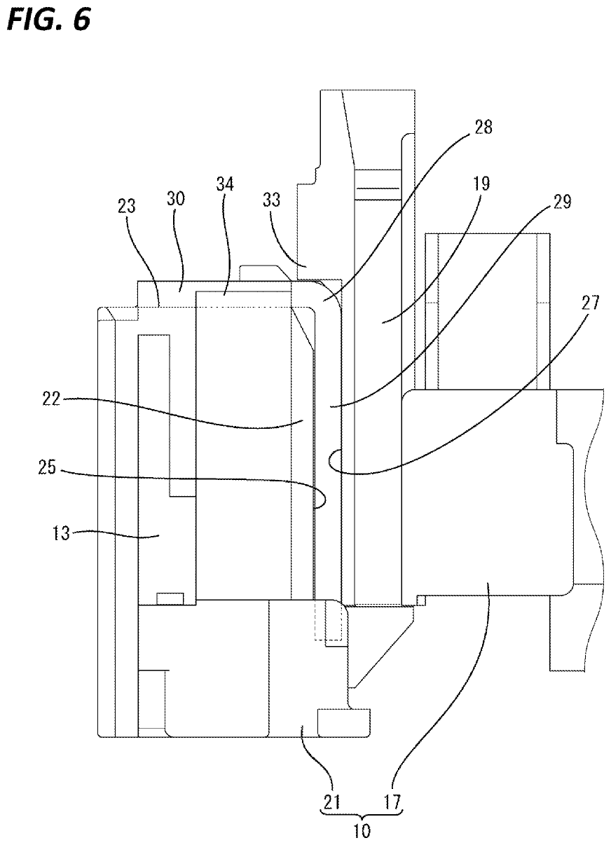

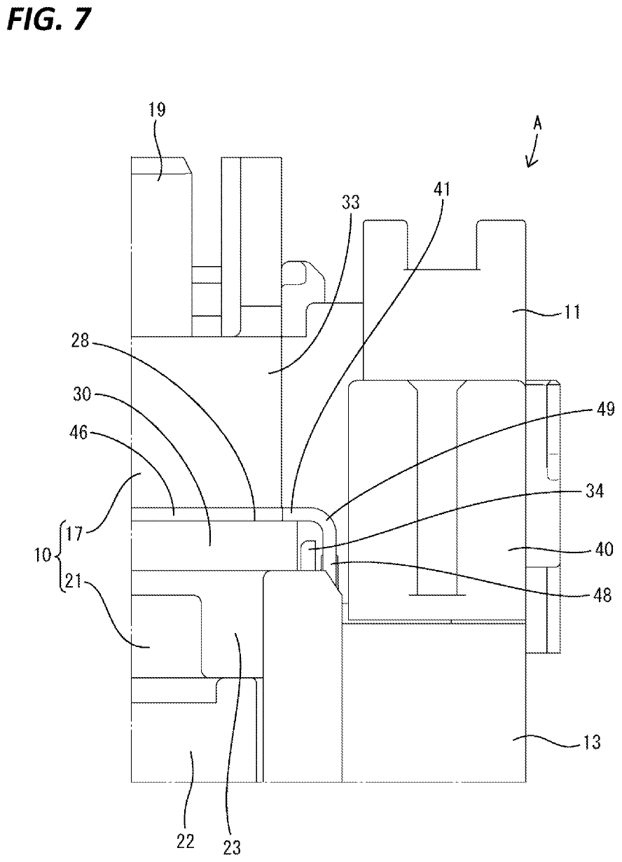

Embodiment 1 that is a specific example of the electrical junction box according to the present disclosure will be described with reference to FIGS. 1 to 7. Note that the present invention is not limited to these examples: the present invention is indicated by the claims, and is intended to include all modifications that are within the meaning and scope of equivalents of the claims. In present embodiment 1, in regard to the front and rear directions of an electrical junction box A, the diagonal lower side in FIGS. 1 to 5 and the left side in FIG. 6 are defined as the front side. In regard to the upper and lower directions, the directions in FIGS. 1 to 7 are defined, as-is, as the upper and lower sides. In regard to the left and right directions, the direction that is orthogonal to the drawing in FIG. 6 is defined as the left-right direction, and the directions in FIG. 7 are defined, as-is, as the left and right sides.

### Overview of Electrical Junction Box A

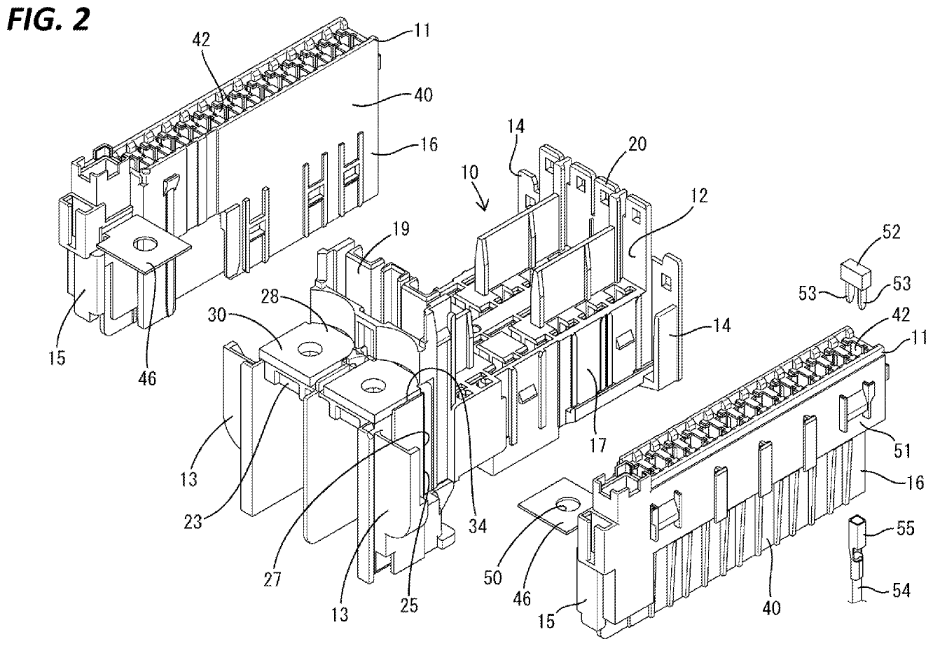

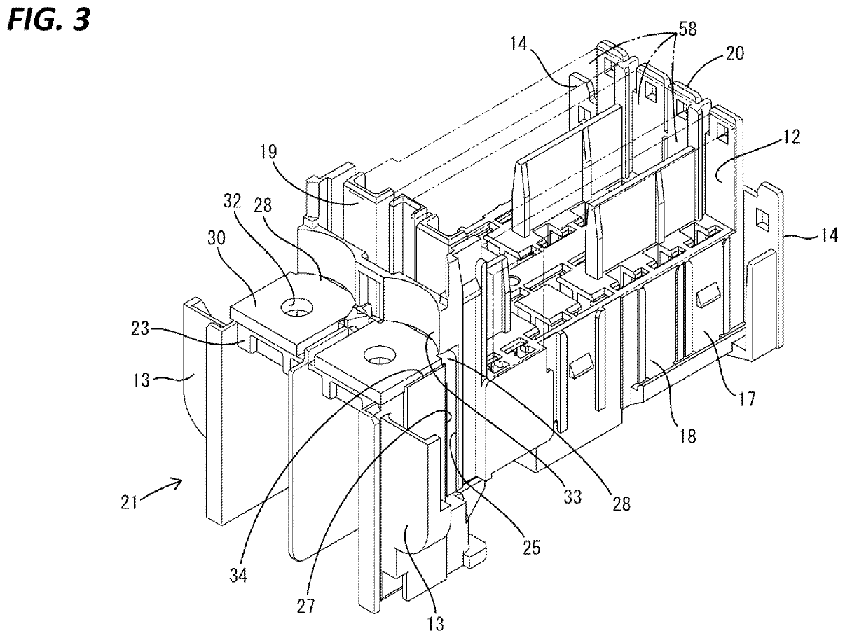

As illustrated in FIGS. 1 and 2, the electrical junction box A according to present embodiment 1 includes one base member 10 and a bilaterally symmetrical pair of side-wall members 11. The pair of side-wall members 11 are attached to the base member 10 so as to sandwich the base member 10 from the left and right sides. As illustrated in FIG. 1, the electrical junction box A includes a component housing chamber 12 that is defined by the base member 10 and the pair of side-wall members 11. The component housing chamber 12 is open in the upper surface of the electrical junction box A. The component housing chamber 12 is configured such that a plurality of electric components 58 (see FIG. 3), such as fusible links, can be housed inside the component housing chamber 12.

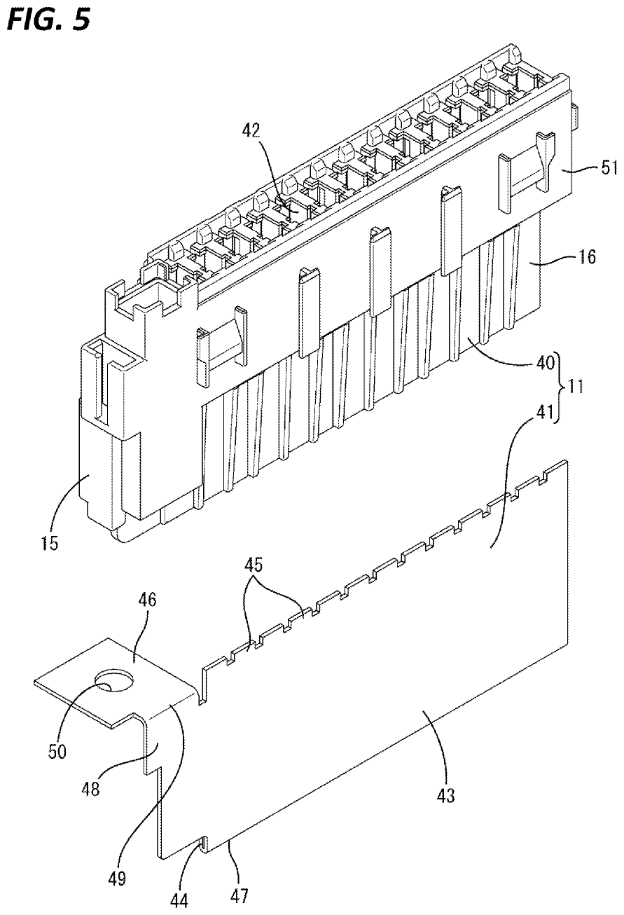

A pair of left and right front-side fitting portions 13 are formed in the front end portion of the base member 10, and a pair of left and right rear-side fitting portions 14 are formed in the rear end portion of the base member 10. As illustrated in FIGS. 2 and 5, a pair of left and right front-side insertion portions 15 are formed in the front end portions of the side-wall members 11, and a pair of left and right rear-side insertion portions 16 are formed in the rear end portions of the side-wall members 11. The base member 10 and the side-wall members 11 are held in an attached state as a result of the front-side fitting portions 13 and the front-side insertion portions 15 being fit to one another, and the rear-side fitting portions 14 and the rear-side insertion portions 16 being fit to one another.

### Base Member 10

The base member 10 includes a holding member 17 made from synthetic resin, a terminal block 21 that is made from synthetic resin and that is a separate component from the holding member 17, and plates 28 that are a bilaterally symmetrical pair of connection components. The number of electric components 58 to be mounted on the base member 10 is more than the number of plates 28. The holding member 17 is a single component including a cuboid-shaped main body portion 18 whose long sides are oriented in the front-rear direction, a front plate portion 19 that extends upward from the front end edge of the main body portion 18, and a rear plate portion 20 that extends upward from the rear end edge of the main body portion 18. The space surrounded by the upper surface of the main body portion 18, the rear surface of the front plate portion 19, and the front surface of the rear plate portion 20 functions as the component housing chamber 12. In a state in which the side-wall members 11 are not attached to the base member 10, the component housing chamber 12 is open to the outside of the base member 10 in the upper surface of the base member 10 and the left and right side surfaces of the base member 10. The pair of rear-side fitting portions 14 are formed in the left and right end portions of the rear plate portion 20.

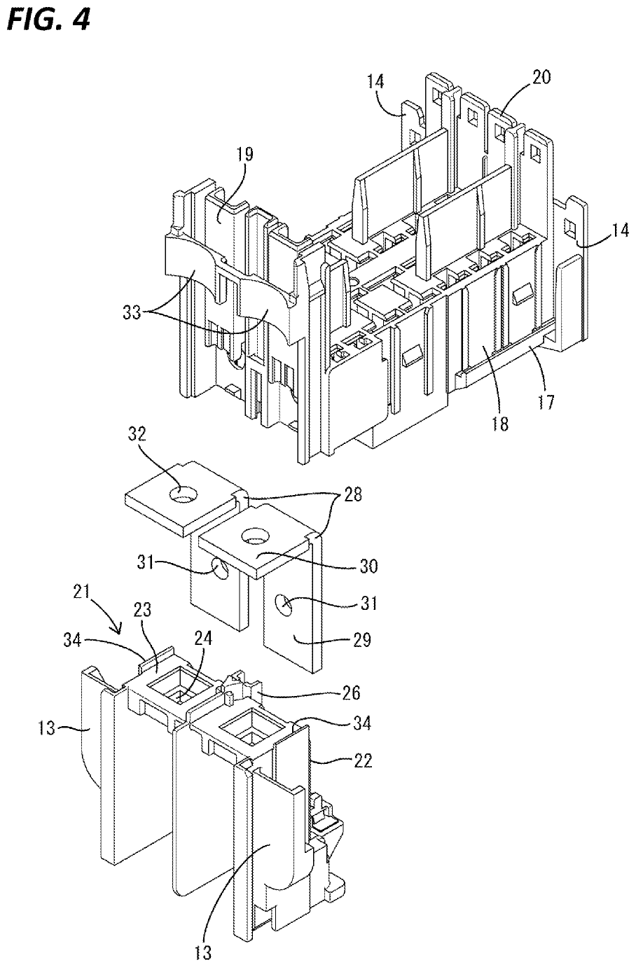

As illustrated in FIG. 4, the terminal block 21 is a single component including supporting plate portions 22 whose plate-thickness directions are oriented in the front-rear direction, and receiving plate portions 23 whose plate-thickness directions are oriented in the up-down direction. Bolt holes 24 that pass through the receiving plate portions 23 in the up-down direction are formed in the receiving plate portions 23. The pair of front-side fitting portions 13 are formed in the left and right end portions of the terminal block 21. The terminal block 21 is attached to the holding member 17 such that the supporting plate portions 22 cover the front surface of the front plate portion 19.

As illustrated in FIG. 6, a pair of left and right housing spaces 25 are formed between the front plate portion 19 of the holding member 17 and the supporting plate portions 22 of the terminal block 21. The pair of housing spaces 25 are disposed so as to be arranged in the left-right direction with a barrier wall portion 26 (see FIG. 4) therebetween. In the left and right outer side surfaces of the base member 10, the housing spaces 25 are open as slit-shaped openings 27 extending in the up-down direction. The upper end portions of the housing spaces 25 are open toward the front of the base member 10 in the shape of left-right-direction slits.

As illustrated in FIG. 4, each plate 28 is a single component formed by bending a thin metal plate material in a right angle. Each plate 28 includes a plate-shaped power supply portion 29 and a plate-shaped mounting portion 30 that are continuous with one another with a right angle therebetween. The plate-shaped power supply portion 29 has the shape of a flat plate whose plate-thickness direction is oriented in the front-rear direction. In a front view, the plate-shaped power supply portion 29 has the shape of a rectangle whose long sides are oriented in the up-down direction. A power-supply connection hole 31 that passes through the plate-shaped power supply portion 29 in the front-rear direction is formed in the plate-shaped power supply portion 29. The plate-shaped mounting portion 30 has the shape of a flat plate whose plate thickness direction is oriented in the up-down direction, and extends toward the front from the upper end edge of the plate-shaped power supply portion 29. In a plan view, the plate-shaped mounting portion 30 is rectangular. A mounting hole 32 that passes through the plate-shaped mounting portion 30 in the up-down direction is formed in the plate-shaped mounting portion 30.

As illustrated in FIG. 6, the plates 28 are attached to the base member 10 in a state in which the plate-shaped power supply portions 29 thereof are housed inside the housing spaces 25. In a state in which the plates 28 have been attached to the base member 10, the plate-shaped mounting portions 30 are exposed to the outside toward the front from the upper end portions of the housing spaces 25, and are mounted on the receiving plate portions 23 of the terminal block 21. Thus, the plates 28 are restricted from moving downward relative to the base member 10, or the terminal block 21 in specific. Holding projections 33 that project from the front plate portion 19 are in contact with the upper end portions of the plate-shaped power supply portions 29, or in other words, the rear end portions of the plate-shaped mounting portions 30. Thus, the plates 28 are restricted from moving upward relative to the terminal block 21.

The hole edge portions of the power-supply connection holes 31 in the plate-shaped power supply portions 29 are exposed to the outside of the terminal block 21 on the front surfaces of the supporting plate portions 22. Power-supply terminals (unillustrated) connected to a battery (unillustrated) are connected to the plate-shaped power supply portions 29 via the power-supply connection holes 31.

In the openings 27 of the housing spaces 25, the entire outer side surfaces of the plate-shaped power supply portions 29 are exposed. Thus, there is a concern that the plates 28 inside the housing spaces 25 may slide in the left-right direction and separate from the openings 27 to the outside of the base member 10. As a countermeasure against this, separation-restricting portions 34 are provided to the receiving plate portions 23, on which the plate-shaped mounting portions 30 are mounted. As illustrated in FIGS. 4, 6, and 7, a separation-restricting portion 34 is disposed on the opening 27-side side edge among the left and right side edges of each receiving plate portion 23, and has the shape of a thin rib in the front-rear direction. The separation-restricting portion 34 projects higher than the receiving plate portion 23, and is disposed so as to face the plate-shaped mounting portion 30 from an outer side in the left-right direction. Even if the plate-shaped power supply portions 29 inside the housing spaces 25 are urged to move toward the outside in the left-right direction from the openings 27, the plate-shaped power supply portions 29 are prevented from separating from the openings 27 as a result of the plate-shaped mounting portions 30 coming into contact with the separation-restricting portions 34. Thus, the plates 28 are held in a state in which the plates 28 are attached to the base member 10.

### Side-Wall Members 11

Each side-wall member 11 is formed by attaching a side-wall main body 40 made from synthetic resin and a busbar 41 made from metal to one another. The side-wall main body 40 is a single component which has a shape that is long in the front-rear direction in a plan view, and whose wall-thickness direction is oriented in the left-right direction. Inside the side-wall main body 40, one busbar housing chamber (unillustrated), a plurality of cavities (unillustrated), and a plurality of fuse housing chambers 42 are formed. The busbar housing chamber is a narrow space that has a left-right dimension smaller than the front-rear and up-down dimensions. The busbar housing chamber is open in the shape of a slit extending in the front-rear direction in the lower surface of the side-wall main body 40. The busbar 41 is attached to the inside of the busbar housing chamber.

The busbar 41 is a single component that is formed by bending a metal flat plate punched out in a predetermined shape. As illustrated in FIG. 5, the busbar 41 includes one flat-plate-shaped substrate portion 43 whose plate-thickness direction is oriented in the left-right direction, one flat-plate-shaped heat-dissipating plate portion 44, a plurality of tabs 45, and one connection plate portion 46. In a side view in which the busbar 41 is seen from the left-right direction, the substrate portion 43 and the heat-dissipating plate portion 44 have the shape of rectangles. The heat-dissipating plate portion 44 is disposed so as to overlap with the inner side surface of the substrate portion 43. The lower end of the substrate portion 43 and the lower end of the heat-dissipating plate portion 44 are connected via a fold-back portion 47 that has a U-shaped cross-section. The plurality of tabs 45 project upward from the upper end edge of the substrate portion 43, and are disposed so as to be arranged in the front-rear direction with spaces therebetween.

The substrate portion 43 includes a supporting portion 48 that projects in flush with the substrate portion 43 toward the front from the front end edge of the substrate portion 43. The connection plate portion 46 has the shape of a flat plate, and is supported by the upper end edge of the supporting portion 48 via a bend portion 49. In a front view in which the busbar 41 is seen from the front, the bend portion 49 exhibits the shape of a quarter circular arc. The lower end portion of the bend portion 49 and the upper end portion of the supporting portion 48 are tangentially continuous with one another. The bend portion 49 projects further inward than the substrate portion 43 from the supporting portion 48, or in other words, toward the base member 10-side from the substrate portion 43 in the left-right direction. The connection plate portion 46 tangentially extends inward from the projecting end portion of the bend portion 49. The connection plate portion 46 is supported horizontally and forms a right angle with the substrate portion 43. A through-hole 50 that passes through the connection plate portion 46 in the up-down direction is formed in the connection plate portion 46.

The busbar 41 is attached to the side-wall main body 40 in a state in which the substrate portion 43, the heat-dissipating plate portion 44, and the tabs 45 are housed inside the busbar housing chamber. The connection plate portion 46 of the busbar 41 is exposed to the outside of the side-wall main body 40, and projects further inward than the side-wall main body 40 in the left-right direction, in other words, toward the base member 10-side. The connection plate portion 46 is mounted on the upper surface of a plate-shaped mounting portion 30 of a plate 28.

A wide enlarged-width portion 51 is formed in the upper end portion of the side-wall main body 40. In the enlarged-width portion 51, the plurality of fuse-housing chambers 42 open in the upper surface of the side-wall main body 40 are disposed so as to be arranged in a single line in the front-rear direction. The lower end portions of the plurality of fuse housing chambers 42 are in communication with the busbar housing chamber. Fuses 52 are attached to the fuse housing chambers 42 from above the side-wall member 11. One of the two leads 53 of each fuse 52 is connected to a tab 45 of the busbar 41. In the lower-end-side region of the enlarged-width portion 51, the plurality of cavities open in the lower surface of the side-wall main body 40 are disposed so as to be arranged in a single line in the front-rear direction. The upper ends of the plurality of cavities are individually in communication with the lower ends of the plurality of fuse housing chambers 42. Inside the cavities, harness terminals 55 that are individually connected to a plurality of electric wires 54 forming a wire harness are housed. The harness terminals 55 are connected to the other leads 53 of the fuses 52.

### Assembly Procedure of Electrical Junction Box A

Upon assembling the electrical junction box A, the holding member 17 and the terminal block 21 are separated from one another as illustrated in FIG. 4. In this state, the terminal block 21 is made to temporarily hold the plates 28 in a state in which the plate-shaped mounting portions 30 are mounted on the receiving plate portions 23 and the plate-shaped power supply portions 29 are placed on the rear surface of the terminal block 21. Next, the terminal block 21 and the plates 28 are attached to the holding member 17 by being pressed into the holding member 17 from below. By attaching the terminal block 21 to the holding member 17, the housing spaces 25 are formed and the plate-shaped power supply portions 29 of the plates 28 are housed inside the housing spaces 25, and the assembly of the base member 10 is complete.

After assembling the base member 10, the electric components 58 are attached to the holding member 17 from above the base member 10 such that the electric components 58 are housed inside the component housing chamber 12. As illustrated in FIG. 3, the component housing chamber 12 is open to the left and right sides of the base member 10. Thus, the fingers that a worker uses to pinch the electric components 58 do not interfere with the base member 10 if the worker pinches the electric components 58 from the left and right sides. Accordingly, the workability during the attachment of electric portions is good. In addition, in a case in which the electric components 58 are mounted using an automatic machine, fingers of the automatic machine do not interfere with the base member 10 if the electric components 58 are held so as to be pinched from the left and right sides using the fingers of the automatic machine.

In a state in which the side-wall members 11 have not been attached to the base member 10, all areas of the housing spaces 25 are open in the outer side surfaces of the base member 10 as the openings 27. Thus, there is a concern that the plate-shaped power supply portions 29 inside the housing spaces 25 may fall out from the openings 27 and separate from the holding member 17 and the terminal block 21 when the base member 10 is tilted to positions such that the side surfaces are oriented downward. As a countermeasure against this, the separation-restricting portions 34, which restrict the displacement of the plate-shaped mounting portions 30 in the left-right direction, are formed in the terminal block 21. Thus, even if the base member 10 is tilted, the plates 28 do not separate from the holding member 17 and the terminal block 21.

By subsequently attaching the pair of side-wall members 11 to the base member 10, the component housing chamber 12 is covered from the left and right sides by the side-wall members 11, and the assembly of the electrical junction box A is complete. The component housing chamber 12 is surrounded over the entire circumference thereof, from the front-rear and left-right directions.

In the state in which the side wall members 11 have been attached to the base member 10, the front end portions of the side-wall members 11 are positioned so as to cover the openings 27 of the housing spaces 25. The connection plate portion 46 of each busbar 41 is placed on the upper surface of the plate-shaped mounting portion 30 of a plate 28. A bolt (unillustrated) is inserted through the through-hole 50, mounting hole 32, and bolt hole 24. By screwing and fastening the bolt into a nut (unillustrated) provided on the lower surface of the receiving plate portion 23, the plate 28 and the busbar 41 are fixed to the terminal block 21. As illustrated in FIG. 7, the bend portion 49 extending obliquely downward from the connection plate portion 46 and the upper end portion of the support portion 48 are positioned so as to cover the entirety of a separation-restricting portion 34 from above and from sideways.

### Operation and Effect of Embodiment

The electrical junction box A according to the present embodiment includes: a base member 10 to which electric components 58 are to be attached: and plates 28 to be connected to the electric components 58. The base member 10 includes housing spaces 25 in which at least part of the plates 28 are housed: and openings 27 that open the housing spaces 25 to outer surfaces of the base member 10. The base member 10 has formed therein separation-restricting portions 34 that restrict the plates 28 inside the housing spaces 25 from separating from the openings 27. The plates 28 are held in a state of being housed inside the housing spaces 25 by the separation-restricting portions 34 even if the base member 10 is placed in positions in which the openings 27 are oriented downward. Accordingly, the electrical junction box A according to the present embodiment has excellent workability during the attachment of other members on the base member 10 and the plates 28.

The base member 10 includes a holding member 17 that holds the electric components 58, and a terminal block 21 to which the plates 28 are fixed. Spaces between the holding member 17 and the terminal block 21 function as the housing spaces 25. The plates 28 can be housed inside the housing spaces 25 by interposing the plates 28 between the holding member 17 and the terminal block 21 when the holding member 17 and the terminal block 21 are attached to one another. Workability during assembly is excellent because the assembly of the base member 10 and the attachment of the plates 28 to the base member 10 can be performed simultaneously in a single process.

The shape of the holding member 17 is more complicated than that of the terminal block 21 because the holding member 17 holds the electric components 58 in a quantity that is greater than the quantity of the plates 28. In view of this, the separation-restricting portions 34 are not formed in the holding member 17, and are formed in the terminal block 21, which has a simpler shape than the holding member 17. Thus, an increase in complexity of the shape of the holding member 17 that may otherwise occur due to the separation-restricting portions 34 being formed in the holding member 17 can be avoided, and the die cost for molding the holding member 17 can be reduced.

Busbars 41 include a substrate portion 43, a quarter-circular-arc-shaped bend portion 49 that extends from the substrate portion 43, and a connection plate portion 46 that extends from the bend portion 49 in the right-angle direction relative to the substrate portion 43. The busbars 41 are disposed in a state in which the connection plate portions 46 are placed on the upper surfaces of plate-shaped mounting portions 30 of the plates 28 and the bend portions 49 face outer side surfaces of the plates 28 with spaces therebetween in the left-right direction. The separation-restricting portions 34 are disposed between the bend portions 49 and the plate-shaped mounting portions 30 of the plates 28. Because the separation-restricting portions 34 are disposed in dead spaces between the plates 28 and the bend portions 49, dedicated spaces for disposing the separation-restricting portions 34 are unnecessary.

The base member 10 includes a component housing chamber 12 for housing the electric components 58. The component housing chamber 12 is open to the left and right sides of the base member 10. A pair of side-wall members 11 for covering the sideways-open surfaces of the component housing chamber 12 are attached to the base member 10.

The side-wall members 11 cover the openings 27 of the housing spaces 25. According to this configuration, the plates 28 can be reliably prevented from separating from the housing spaces 25, by means of the side-wall members 11 as well.

### Other Embodiments

The present invention is not limited to the embodiment described based on the drawings and the description above, but defined in the claims. The present invention includes all modifications that are included in the claims and that are within the meaning and scope of equivalents of the claims, and is intended to also include the following embodiments.

In embodiment 1 described above, the assembly of the base member and the attachment of the connection members to the base member are performed simultaneously in a single process: however, the connection members may be attached to the base member after the base member has been assembled.

In embodiment 1 described above, the separation-restricting portions are formed only in the terminal block; however, the separation-restricting portions may be formed only in the holding member, or may be formed in both the terminal block and the holding member.

In embodiment 1 described above, the separation-restricting portions are disposed in the dead spaces between the connection members and the bend portions; however, the separation-restricting portions may be disposed in positions other than the dead spaces between the connection members and the bend portions.

In embodiment 1 described above, the openings of the housing spaces are covered by the side-wall members: however, the openings of the housing spaces may be left open.

### LIST OF REFERENCE NUMERALS

A Electrical junction box
10 Base member
11 Side-wall member
12 Component housing chamber
13 Front-side fitting portion
14 Rear-side fitting portion
15 Front-side insertion portion
16 Rear-side insertion portion
17 Holding member
18 Main body portion
19 Front plate portion
20 Rear plate portion
21 Terminal block
22 Supporting plate portion
23 Receiving plate portion
24 Bolt hole
25 Housing space
26 Barrier wall portion
27 Opening
28 Plate (connection member)
29 Plate-shaped power supply portion
30 Plate-shaped mounting portion
31 Power-supply connection bole
32 Mounting hole
33 Holding projection
34 Separation-restricting portion
40 Side-wall main body
41 Busbar
42 Fuse housing chamber
43 Substrate portion
44 Heat-dissipating plate portion
45 Tab
46 Connection plate portion
47 Folded-back portion
48 Supporting portion
49 Bend portion
50 Through-hole
51 Enlarged-width portion
52 Fuse
53 Lead
54 Electric wire
55 Harness terminal
58 Electric component

1. An electrical junction box comprising:
a base member to which electric components are to be attached; and
connection members to be connected to the electric components,
wherein the base member includes housing spaces in which the connection members are housed, and openings that open the housing spaces to outer surfaces of the base member, and
the base member has formed therein separation-restricting portions that restrict the connection members inside the housing spaces from separating from the openings.

2. The electrical junction box according to claim 1,
wherein the base member includes a holding member that holds the electric components, and a terminal block to which the connection members are fixed, and
spaces between the holding member and the terminal block function as the housing spaces.

3. The electrical junction box according to claim 2,
wherein the holding member is capable of holding the electric components in a quantity that is greater than the quantity of the connection members, and
the separation-restricting portions are formed only in the terminal block.

4. The electrical junction box according to claim 1 further comprising
busbars that include a substrate portion, a quarter-circular-arc-shaped bend portion that extends from the substrate portion, and a connection plate portion that extends from the bend portion in the right-angle direction relative to the substrate portion,
wherein the busbars are disposed in a state in which the connection plate portions are placed on the connection members and the bend portions face outer side surfaces of the connection members, and
the separation-restricting portions are disposed between the connection members and the bend portions.

5. The electrical junction box according to claim 1,
wherein the base member includes a component housing chamber for housing the electric components,
the component housing chamber is open to the sides of the base member,
side-wall members for covering the sideways-open surfaces of the component housing chamber are attached to the base member, and
the side-wall members cover the openings of the housing spaces.
